(19) United States
(12) Patent Application Publication
(10) Pub. No.: US 2008/0071864 A1
(43) Pub. Date: Mar. 20, 2008

(54) SYSTEM AND METHOD FOR USER INTEREST BASED SEARCH INDEX OPTIMIZATION

(75) Inventors: Igor L. Belakovskiy, Cambridge, MA (US); David A. Brooks, Providence, RI (US); Niklas Heidloff, Salzkotten (DE); Craig R. Wolpert, Holliston, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/531,710

(22) Filed: Sep. 14, 2006

(51) Int. Cl. G06F 17/30; G06F 15/16; G06F 15/173

(52) U.S. Cl. 709/206; 514/269; 707/1; 709/223

(57) ABSTRACT

A system and a method for providing user interest based search index optimization. The system includes a server node configured to transmit electonic mail, and a client node having an electronic recepticle and a dynamic interest profile member (DIP). The client node is interconnected to the server node via a network. The client node is configured to receive in the electronic receptacle the transmitted electronic mail. The DIP is configured to assign a DIP ranking to each piece of received electronic mail predicated upon at least one of, (i) the identity of the sender, and (ii) the keywords listed in the contents of the electronic mail. The DIP ranking of the electronic mail is compared to a DIP threshold; the electronic mail is added to a full text index located in the client node when the DIP ranking of the electronic mail exceeds the DIP threshold.

### TRADEMARKS

IBM® is a registered tradmeark of International Business Machines Coproration, Armonk, N.Y., U.S.A. Other names used herein may be registered trademarks, trademarks or product names of International Business Machines Corporation or other companies.

### BACKGROUND OF THE INVENTION

1. Field of the Invention

This invention relates in general to electronic communication, and more particularly, to minimizing the amount of space taken up by a full text index utilized by electronic mail.

2. Description of Background

Indexing of documents is an expensive operation. For a single document to be indexed, it requires conversion from the document markup to a plain text format, language detection, tokenization and insertion into a forward index to be later built is not a main index. This process consumes both CPU and disk space for each document indexed.

In an on-demand application environment, applications are subdivided into logical components that operate independently but still share platform resources. Each application can intercommunicate with other applications in this environment. To optimize the performance of a platform level indexing service in an on-demand environment, the service needs to eliminate unnecessary processing and resource consumption.

Thus, there is a need for a system and a method for providing user interest based search index optimization.

### SUMMARY OF THE INVENTION

The shortcomings of the prior art are overcome and additional advantages are provided through the provision of a system for providing user interest based search index optimization. The system includes a server node that is configured to transmit electronic mail. The system further includes a client node having an electronic receptacle and a dynamic interest profile member (DIP). The client node being interconnected to the server node via a network. The client node is configured to receive in the electronic receptacle the transmitted electronic mail. The DIP is configured to assign a DIP ranking to each piece of received electronic mail. The ranking being predicated upon at least one of, (i) the identity of the sender, and (ii) the keywords listed in the contents of the electronic mail. The DIP ranking of the electronic mail is compared to a DIP threshold. The electronic mail is added to a full text index located in the client node when the DIP ranking exceeds the DIP threshold. The full text index being operably associated with the electronic receptacle and the DIP.

The shortcomings of the prior art are overcome and additional advantages are provided through the provision of a method for providing user interest based search index optimization including transmitting electronic mail via a server node. Then receiving the electronic mail at a client node. The client node having an electronic receptacle and a dynamic interest profile member (DIP). The electronic receptacle and the DIP being operably associated with one another and the client node being operably associated with the server node via a network interconnecting the server node and the client node. Then assigning a DIP ranking via the DIP to each piece of electronid mail predicated upon at least one of, (i) the identity of the sender, and (ii) the keywords listed in the contents of the electronic mail. Then comparing the DIP ranking of the electronic mail to a DIP threshold and adding the electronic mail to a full text index located in the clients node when the DIP ranking exceeds the DIP threshold.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a system and a method for providing user interest based search index optimization.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a system for providing user interest based search index optimization in accordance with the disclosed invention; and

FIG. 2 illustrates one example of an alternative embodiment for providing user interest based search index optimization in accordance with the disclosed invention.

The detailed description explains an exemplary embodiment of the invention, together with advantages and features, by way of example with reference to the drawings.

### DETAILED DESCRIPTION OF THE INVENTION

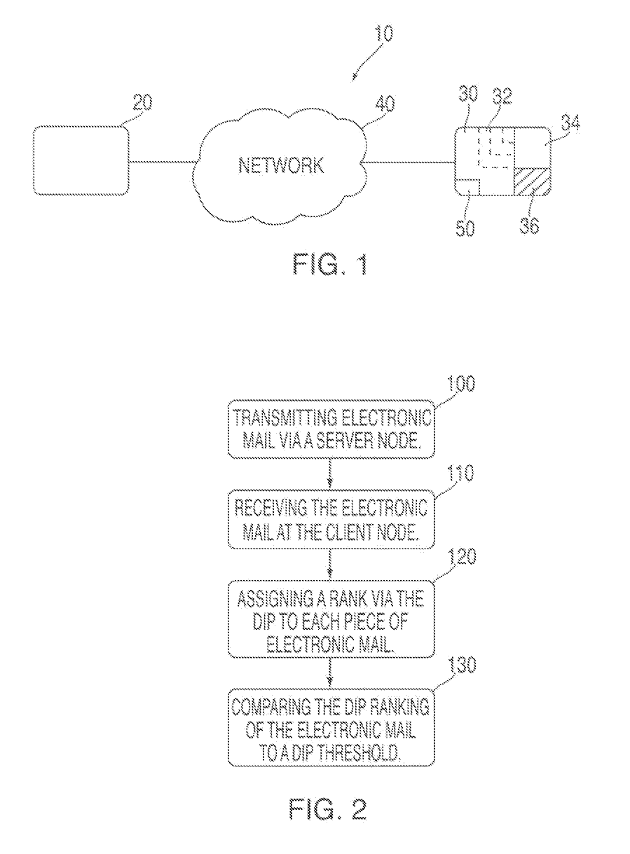

Referring to FIG. 1, a system 10 for providing user interest based search index optimization is shown. The system 10 most likely will reduce the amount of space taken up by text indexing. This is very important for hand-held devices. The system 10 includes a server node 20 that is configured to transmit electronic mail.

A network 40 interconnects a client node 30 and the server node 20. The client node 30 includes an electronic receptacle 32 and a dynamic interest profile member (DIP) 34. The client node 30 is configured to receive the transmitted electronic mail via the electronic receptacle 32. The DIP 34 shall change as the user's interest evolves over a period of time. In order to reflect these changes during text indexing, two tasks must be performed: (i) adding new documents to reflect recent interests, and (ii) removing documents to reflect topics the user is no longer interested in,

The DIP 34 is a mechanism for ranking the importance of a piece of electronic mail. The ranking is generated based on the content of the electronic mail, as well as the sender of the electronic mail. The DIP 34 keeps track of the topics most important to the user by extracting keywords the user has shown interest in. Through a user interface at the client node, the user may define the identity of the senders that increase the DIP ranking and (ii) the keywords listed in the contents of the electronic mail that increase the DIP ranking. The user may also assign varying weights to the senders and keywords so that the effect of the sender or keyword on the DIP ranking can vary. For example, and email from a high level manager may contribute more to the DIP ranking than an email from a friend. The user may periodically adjust these weights, including eliminating senders or keywords from adding to the DIP ranking, as interests change.

The DIP 34 is configured to assign a DIP ranking to each piece of received electronic mail. The ranking is predicated upon at least one of, (i) the identity of the sender, and (ii) the keywords listed in the contents of the electronic mail. As noted above, emails from a particular sender or containing certain keywords may be associated with a higher DIP ranking by the user.

The DIP ranking of the electronic mail is compared to a DIP threshold. The electronic mail is added to a full text index 36 located in the client node 30 when the DIP ranking exceeds the DIP threshold. The full text index 36 is operably associated with the electronic receptacle 32 and the DIP 34. The DIP 34 may also be utilized by the user to index a web document, a web page, a document library or a personal search index. The same principle would apply, which is only the important web documents, web pages, library documents and personal search index documents will be indexed. If applied to the web, the DIP 34 may rely only on keywords and/or would replace the sender with the source web site. The optimization based on DIP rankings are not restricted to mail, and may be applied to desktop indexing applications, which also index documents and web pages.

The DIP 34 is configured to change as the user's interest evolves over a period of time, these changes being reflected in text indexing by at least one of, (i) adding new documents to reflect recent interests, and (ii) removing documents to reflect topics the user is no longer interested in. Furthermore, the DIP is configured to enhance recall type searches and not research type searches.

An indicator 50 may be included in the client node 30 for indicating that the document has been automatically added to the full text index 36. Furthermore, the client node 30 allows the user to manually add the electronic mail, the web document and the web page to the full text index 36 despite the DIP 34 ranking of the electronic mail, the web document or the web page.

In order for the electronic mail to be added to the full text index 36, the original transmitted document markup must be converted to a plain text format as well as undergo language detection. Afterwards, the plain text format of the electronic mail is tokenized prior to being indexed in the full text index 36.

Referring to FIG. 2, a method for providing user interest based search index optimization is shown. Starting at step 100, electronic mail is transmitted from a server node. Subsequently, at step 110, the electronic mail is received at a client node 30 having an electronic receptacle and a dynamic interest profile member (DIP). The electronic receptacle and the DIP are operabley associated with one another. The client node is operably associated with the server node via a network that interconnects the server node and the client node.

Next, at step 120, a DIP ranking is assigned to each piece of electronic mail predicated upon at least one of, (i) the identity of the sender, and (ii) the keywords listed in the contents of the electronic mail. In conclusion at step 130, the DIP ranking of the electronic mail is compared to a DIP threshold and electronic mail is added to a full text index located in the client node when the DIP ranking exceeds the DIP threshold.

Optionally, at step 140, an indication that the indexed document has been automatically added to the full text index may be invoked.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for providing user interest based search index optimization, comprising:
a server node configured to transmit electronic mail;
a client node having an electronic receptacle and a dynamic interest profile member (DIP), the client node interconnected to the server node via a network, the client node configured to receive in the electronic receptacle the transmitted electronic mail;
wherein the DIP is configured to assign a DIP ranking to each piece of received electronic mail, the ranking being predicated upon at least one of, (i) the identity of the sender, and (ii) the keywords listed in the contents of the electronic mail; and
wherein the DIP ranking of the electronic mail is compared to a DIP threshold, the electronic mail is added toa full text index located in the client node when the DIP ranking exceeds the DIP threshold, the full text index being operably associated with eh electronic receptacle and the DIP.

2. The system of claim 1, wherein the DIP threshold may be set by a user of the client node.

3. The system of claim 2, wherein adding the electronic mail to the full text index requires that the original transmitted document markup be converted to a plain text format, undergo language detection and be tokenized prior to being indexed.

4. The system of claim 3, wherein the DIP may be utilized by the user to index a web document, a web page, a document library and a personal search index.

5. The system of claim 4, wherein the client node further includes an indicator for indicating that the indexed document has been automatically added to the full text index.

6. The system of claim 5, wherein the client node allows the user to manually add the electronic mail, the web document and the web page to the full text index despite the DIP ranking of the electronic mail, the web document and the web page.

7. The system of claim 6, wherein the DIP is configured to change as the user's interest evolves over a period of time, these changes being reflected in text indexing by at least one of, (i) adding new documents to reflect recent interests, and (ii) removing documents to reflect topics the user is not longer interested in.

8. The system of claim 7, wherein the DIP is configured to enhance recall type searches.

9. A method for providing user interest based search index optimization, comprising:
transmitting electronic mail via a server node;
receiving the electronic mail at a client node, the client node having an electronic receptacle and a dynamic interest profile member (DIP), the electronic receptacle and the DIP operably associated with one another and the client node operably associated with the server node via a network interconnecting the server node and the client node;
assigning a DIP ranking via the DIP to each piece of electronic mail predicated upon at least one of, (i) the identity of the sender, and (ii) the keywords listed in the contents of the electronic mail; and
comparing the DIP ranking of the electronic mail to a DIP threshold and adding the electronic mail to a full text index located in the client node when the DIP ranking exceeds the DIP threshold.

10. The method of claim 9, wherein the DIP threshold may be utilized by the user to index a web document, a web page, a document library and a personal search index.

11. The method of claim 10, wherein adding the electronic mail to the full text index requires that the original transmitted document markup be converted to a plain text format, undergo language detection and be tokenized prior to being indexed.

12. The method of claim 11, wherein the DIP may be set by the user to index a web document and a web page.

13. The method of claim 12, further including:
indicating via an indicator that the indexed documentt has been automatically added to the full text index.

14. The method of claim 13, wherein the client node allows the user to manually add the electronic mail, the web document and the web page to the full text index despite the DIP ranking of the electronic mail, the web document and the web page.

15. The method of claim 14, wherein the DIP is configured to change as the user's interest evolves over a period of time, these changes being reflected in text indexing by at least one of, (i) adding new documents to reflect recent interests, and (ii) removing documents to reflect topics the user is no longer interested in.

16. The method of claim 15, wherein the DIP is configured to enhance recall type searches.
